(19) United States
(12) Patent Application Publication
(10) Pub. No.: US 2015/0009233 A1
(43) Pub. Date: Jan. 8, 2015

(54) Asset-Linked Augmented Reality With User Generated Content and User Assigned Editable Links

(71) Applicants: Dylan Phillips, Jacksonville, FL (US); Anthony Goria, Fleming Island, FL (US)

(72) Inventors: Dylan Phillips, Jacksonville, FL (US); Anthony Goria, Fleming Island, FL (US)

(21) Appl. No.: 14/323,551

(22) Filed: Jul. 3, 2014

Related U.S. Application Data
(60) Provisional application No. 61/842,683, filed on Jul. 3, 2013.

(51) Int. Cl. G06T 19/00

(52) U.S. Cl. CPC G06T 19/006
USPC 345/633

(57) ABSTRACT

Systems, methods and computer program products are disclosed that facilitate content sharing coupled with a producer-designated physical asset. Specifically, in an aspect, systems, methods, and computer program products are disclosed wherein an augmented reality experience is created for a consumer. The augmented reality experience comprises content (e.g., a video, image, audio file, and the like) created by a producer for the consumer. The content is linked by the producer with a physical asset chosen by the producer via a producer key. The consumer may access the augmented reality experience via a computing device by providing a consumer key and detecting the producer-designated physical asset with the computing device.

### CROSS REFERENCE TO RELATED APPLICATION

This application claims the benefit of U.S. Provisional Patent Application No. 61/842,683, filed Jul. 3, 2013, and entitled “Asset-Linked Augmented Reality With User Generated Content,” the entire contents of which is incorporated herein by reference.

### FIELD OF THE DISCLOSURE

The present disclosure generally relates to contextual communication and more particularly to systems, methods and computer program products for facilitating asset-linked media sharing between one or more individuals.

### BACKGROUND

The statements in this section merely provide background information related to the present disclosure and may not constitute prior art.

Existing augmented reality and computer vision aided information sharing systems are cumbersome and impersonal. Such systems seek to augment the experience of interacting with an environment a user is in by presenting the user with media related to or associated with elements within the environment. The environmental elements are typically detected by a mobile computing device carried or worn by the user. The mobile computing device may be equipped with one or more sensors (e.g., a camera, near-field communications transceiver, Bluetooth® chip (a wireless technology standard standardized as IEEE 802.15.1), GPS sensor, and the like) which can detect the environmental elements.

Upon detecting an environmental element, augmented reality systems typically present additional information to the user. For example, the Monocle® application (available from Yelp, Inc. of San Francisco, Calif.) operates on a user's mobile device (e.g., a smartphone). The Monocle application utilizes an on-board camera, accelerometer, compass, and GPS sensor to determine the environmental elements of the location. Such sensors are also used to determine the attitude and direction the mobile device is pointing. The camera is used to present the user with images of what the camera is pointing at (i.e., other environmental elements such as buildings and roads). As an augmented reality application, the Monocle application overlays the images of the user's environment, as “framed” by the mobile device, with additional information about restaurants, bars, or other destinations. In this manner, Monocle application users may be informed of destinations in the direction their mobile device is pointing and see environmental elements in the direction of such destinations. Additionally, when the user changes the location or orientation of the mobile device, another portion of the user's environment is framed and the Monocle application updates the additional information presented to the user in order to sync with the environment being displayed. Many existing augmented reality systems operate using similar processes.

Augmented reality systems, such as the Monocle application, typically store the additional information to be presented to users on databases accessible via a communications network, such as the global, public Internet. Such databases may be updated by the application service provider, thereby enabling remote updates of additional information presented to users of the augmented reality system.

Computer vision-aided information sharing systems typically present media to the user after an environmental element is detected by the system. QR code reader applications are representative or such systems. QR codes, originally described in U.S. Pat. No. 5,726,435 granted to Masahrio, et al., are two dimensional matrix barcodes comprising three positioning symbols and a data region. The data region consists of a plurality of light regions and dark regions which may be scanned by an image sensor and digitally analyzed by a QR code reader application, yielding information in numeric, alphanumeric, binary, or Kanji form. Such information may contain a reference number, URL, short body of text, or the like. QR code reader applications may operate within a mobile device (e.g., a smartphone). A mobile device user may activate the QR code reader application and scan a QR code using an on-board camera. The QR code reader application then analyzes the captured image of the QR code and decodes the information contained therein. This information is then presented to the user. For example, where the scanned QR code contains a URL, the QR code reader application may launch a web browser and navigate to the webpage associated with the URL. In other usages, the QR code may contain an alphanumeric reference number. In such a usage, the QR code reader application may decode the reference number, access a content database, and present the user with a stored image associated with the reference number.

Although current augmented reality and computer vision aided information sharing systems have been used to share information, such systems are cumbersome because individuals often stumble upon opportunities to receive information via augmented reality and computer vision aided information sharing systems. The user must then quickly decide to utilize a mobile device to access the content by, for example scanning a QR code with a specialized application. What is needed are systems, methods, and computer program products which facilitate utilization of augmented reality systems via providing additional user-controllable environmental elements and inducements to initiate an augmented reality experience.

Many augmented reality and computer vision aided information sharing systems are configured to present information which cannot be altered after the initial creation of the information within the system. For example, an augmented reality experience featuring a URL-encoded QR code which launches a specific webpage cannot be reconfigured to launch a different webpage, thereby limiting the usefulness of the augmented reality experience. Such an experience will be static and decrease in relevance over time. What is needed are systems, methods, and computer program products which facilitate dynamic sharing of content.

Augmented reality is typically used in “one-to-many” communications. That is, existing augmented reality and computer vision aided information sharing systems provide the same or similar information to all users of a system and the information is dictated by the individual or entity which initially creates the system. Because such systems are configured to share the same information with a wide audience of users, they are not suitable for sharing information between individuals, or for sharing private or intimate information. What is needed are systems, methods, and computer program products which facilitate controlled sharing of content in an augmented reality setting.

When integrated into a larger composition, such as a picture, video, advertisement, or the like, the aesthetics of an augmented reality anchor, such as a QR code image, often clashes with the rest of the composition. Although this may draw a viewer's eye to the augmented reality anchor, such a clash distracts the viewer, thereby lessening the impact of the overall composition. What is needed are systems, methods, and computer program products which facilitate an augmented reality experience without utilizing augmented reality anchors which clash with an overall composition.

Absent encouragement by an outside source, individuals typically have little motivation to attempt to use augmented reality devices or applications. What is needed are systems, methods, and computer program products which encourage a user to initiate an augmented reality experience.

### SUMMARY

This Summary is provided to introduce a selection of concepts. These concepts are further described below in the Detailed Description section. This Summary is not intended to identify key features or essential features of this disclosure's subject matter, nor is this Summary intended as an aid in determining the scope of the disclosed subject matter.

Aspects of the present disclosure meet the above-identified needs by providing systems, methods, and computer program products which facilitate content sharing coupled with a producer-designated physical asset. Specifically, in an aspect, systems, methods, and computer program products are disclosed wherein an augmented reality experience is created for a consumer. The augmented reality experience comprises content (e.g., a video, image, audio file, and the like) created by a producer for the consumer. The content is linked by the producer with a physical asset chosen by the producer via a producer key. The consumer may access the augmented reality experience via a computing device by providing a consumer key and detecting the producer-designated physical asset with the computing device.

In an aspect, a producer may change, update, delete, or otherwise modify the content displayed to the consumer during the augmented reality experience.

In an aspect, the computing device detects the physical asset by capturing an image or video of the physical asset. In another aspect, the computing device may detect the physical asset via near-field communications, radio transmissions, Bluetooth® communications, RFID protocols, and the like. Such detection may be interactive, or passive. In another aspect, detection of the physical asset is accomplished by physically contacting the physical asset with a senor, bringing the physical asset within close proximity of the computing device, as determined by GPS sensors, and the like. In another aspect, the computing device may detect the physical asset via emissive detection systems such as LI DAR, RADAR, SONAR, and the like. In another aspect, the computing device detects the physical asset by “passively” collecting signals emitted or reflected off of the physical asset, such as electro-magnetic radiation, thermal energy, acoustic waves, and the like.

In some aspects, detection may require movement of the physical asset. Movement may be the consumer moving the asset. For example, rotating the asset. Movement may be the asset itself moving or changing. For example, a wheel on a device rotating may be detected. Movement may be relative, for example, moving around a building.

An asset record is associated with the physical asset. The asset record comprises image parameters. Image parameters may be a two-dimensional image of all or a portion of the physical asset. In another aspect, image parameters are a three-dimensional coordinate system representing the external surface of the physical asset (e.g., a point cloud, a CAD image of the physical asset). Matching the image parameters with data captured by the computing device from the physical asset allows the computing device to detect the physical asset, thereby facilitating the content sharing disclosed herein.

In an aspect, the image parameters are not configured to contain machine readable data as, for example, QR codes are. Rather, the image parameters may contain aesthetically pleasing markings, symbols, phrases, icons, or the like which may be detected by the computing device. In this manner, systems, methods, and computer program products may facilitate an augmented reality experience without utilizing augmented reality anchors or marker portions which clash with an overall composition of the physical assets utilized.

The physical asset comprises a marker portion. A consumer computing device may be configured to compare information collected about the consumer's surroundings via computing device sensors with the image parameters. The computing device may detect a physical device marker portion and compare such information with the image parameters. Such a comparison may yield a match, indicating the presence of the physical asset. The marker portion may be an image on the surface of the physical asset and the physical asset may be detected via detecting the reproduced image.

In an aspect, the image parameters comprise a two-dimensional image comprising the phrase “I Love Grandma.” The physical asset is a coffee mug comprising a matching “I love Grandma” image, the marker portion. A camera module on a computing device may scan the coffee mug and capture a video frame of the “I Love Grandma” image on the coffee mug. The captured image frame may then be compared to the image parameters, facilitating detection of the physical asset associated with the “I Love Grandma” image parameters.

The physical asset may be selected by a producer. In an aspect, the physical asset is an object such as a cup, t-shirt, bag, promotional item, sign, or the like. Utilization of physical assets which have a personal meaning to the consumer encourages the consumer to take advantage of the associated augmented reality experience. For example, a consumer may have a personal connection with a greeting card, “I Love Grandma” cup, a concert ticket, an event souvenir, or the like. This connection is tied to systems, methods, and computer program products in accordance with the present disclosure, thereby encouraging utilization.

Physical assets may be chosen by a producer and gifted to the consumer. The producer, a new parent for example, may inform the consumer of the content sharing properties of the physical asset. In this manner, the consumer is encouraged to initiate an augmented reality experience as disclosed herein.

In an aspect, the producer is a business, such as a sports event facility management company. The physical asset may be a t-shirt comprising an image of motocross bikes. The motocross bike image is the marker portion. The asset record associated with such t-shirts may contain image parameter related to the motocross bike image. The sports event facility management company may provide consumer keys to each consumer at a motocross rally at the sports event facility. Each consumer may access content generated by the producer by utilizing a personal mobile device. Each consumer may input the consumer key into the device and cause the personal mobile device to scan the t-shirt with an on-board camera, thereby detecting the marker portion and accessing the content. The content may then be displayed by the personal mobile device. In this manner, systems, methods, and computer program products in accordance with the present disclosure may facilitate one-to-many content sharing.

In an aspect, a producer may purchase a physical asset not initially associated with a producer key and a consumer key. A retailer, such as a holiday shop may provide image parameters for some or all products sold by the retailer to service provider. The consumer may first purchase or select a physical asset, such as a holiday ornament, within the holiday shop. The consumer may take the holiday ornament to a kiosk located inside the holiday shop where the consumer purchases an access pass to an augmented reality experience as disclosed herein. The consumer may input information about the physical asset purchased (i.e., the holiday ornament). The access pass comprises a producer key and a consumer key associated with the image parameters of the physical asset purchased by the producer, thereby enabling the producer to create and link content with the purchased physical asset, give the physical asset and the consumer key to a consumer, and share the content with a consumer.

Further features and advantages of the present disclosure, as well as the structure and operation of various aspects of the present disclosure, are described in detail below with reference to the accompanying drawings.

### BRIEF DESCRIPTION OF THE DRAWINGS

The features and advantages of the present disclosure will become more apparent from the Detailed Description set forth below when taken in conjunction with the drawings in which like reference numbers indicate identical or functionally similar elements.

FIG. 1 is a block diagram of an exemplary system for facilitating content sharing coupled with a producer-designated physical asset, according to aspects of the present disclosure.

FIG. 2 is an image illustrating individuals and elements associated with producing content which may be shared, according to aspects of the present disclosure.

FIG. 3 is an image illustrating individuals and elements associated with receiving content shared via an exemplary system for facilitating content sharing coupled with a producer-designated physical asset, according to aspects of the present disclosure.

FIG. 4 is a dataflow diagram of a catalog creation and asset organization process for an exemplary system for facilitating content sharing coupled with a producer-designated physical asset, according to aspects of the present disclosure.

FIG. 5 is a dataflow diagram of an asset token creation process for an exemplary system for facilitating content sharing coupled with a producer-designated physical asset, according to aspects of the present disclosure.

FIG. 6 is an image illustrating individuals and elements associated with producing content which may be shared via an exemplary system for facilitating content sharing coupled with a producer-designated physical asset, according to aspects of the present disclosure.

FIG. 7 is a dataflow diagram of a content sharing process for an exemplary system for facilitating content sharing coupled with a producer-designated physical asset, according to aspects of the present disclosure.

FIG. 8 is dataflow diagram of a content consuming process for an exemplary system for facilitating content sharing coupled with a producer-designated physical asset, according to aspects of the present disclosure.

FIG. 9 is a flowchart illustrating an exemplary process for creating content and an associated augmented reality experience, according to aspects of the present disclosure.

FIG. 10 is a flowchart illustrating an exemplary process for consuming content associated with a physical asset, according to aspects of the present disclosure.

FIG. 11 is a flowchart illustrating an exemplary process for creating content and assigning access to a consumer, according to aspects of the present disclosure.

FIG. 12 is a flowchart illustrating an exemplary process for consuming content, consumer keys for consuming the content being associated with a consumer profile accessible by logging in, according to aspects of the present disclosure.

FIG. 13 is a block diagram of an exemplary computing system useful for implementing aspects of the present disclosure.

### DETAILED DESCRIPTION

The present disclosure is directed to systems, methods, and computer program products that facilitate content sharing coupled with a producer-designated physical asset.

Aspects of the present disclosure provide systems, methods, and computer program products wherein an augmented reality experience is created by a producer for a consumer. The augmented reality experience comprises content created or provided by a producer for the consumer. The content is linked by the producer with a physical asset chosen by the producer via a producer key. The consumer may access the augmented reality experience via a computing device by providing a consumer key and detecting the producer-designated physical asset with the computing device.

The term “content” and/or the plural form of this term are used throughout herein to refer to one or more videos, images, audio files, audiovisual experiences, renderings, and the like. Such content may be interactive (e.g., a virtual assistant) or adaptive (e.g., turn-by-turn directions to a location).

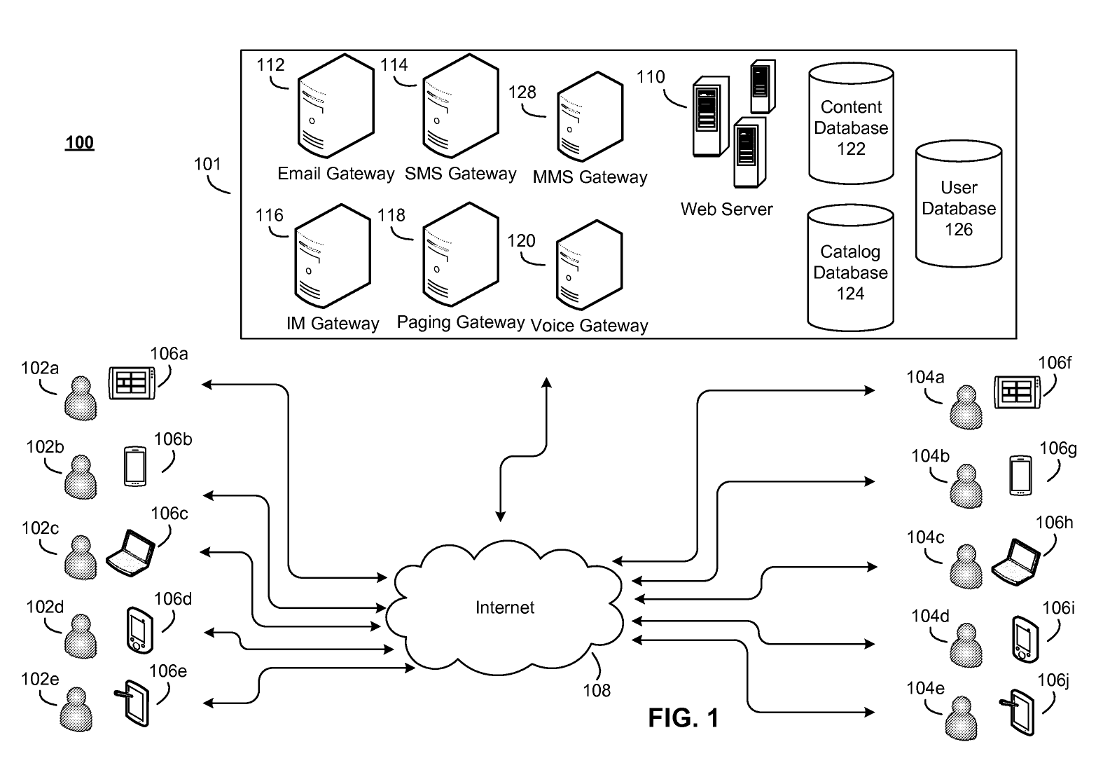

Referring now to FIG. 1, a block diagram of an exemplary system for facilitating content sharing coupled with a producer-designated physical asset, according to an aspect of the present disclosure, is shown.

Cloud-based, Internet-enabled device communication system 100 includes a plurality of producers 102 (shown as producers 102a-d in FIG. 1) and consumers 104 (shown as consumers 104a-d in FIG. 1) accessing—via a computing device 106 (shown as respective computing devices 106a-h in FIG. 1) and a network 108, such as the global, public Internet—an application service provider's cloud-based, Internet-enabled infrastructure 101.

Producer 102 may access infrastructure 101 in order to facilitate sharing content with one or more consumers 104. Producer 102 may also access infrastructure 101 in order to, among other things: facilitate linking content with an asset record; change, update, delete, or otherwise modify the content associated with an asset record; alter which consumers 104 may view producer-provided content; upload additional content; and the like.

Producer 102 may access infrastructure 101 in order to facilitate sharing content with one or more consumers 104 on an individual basis, on behalf of another individual, or on behalf of a company, partnership, or other entity. Producer 102 may act on behalf of others as an independent contractor, an employee, or other agent on an exclusive or non-exclusive basis. Furthermore, agents of an application service provider may act as producer 102 for third parties.

Consumer 104 may access infrastructure 101 in order to facilitate receiving content. Consumer 104 may also access infrastructure 101 to, among other tasks: provide a consumer key; download software modules which enable systems, methods, and computer program products described herein; comment on received content; communicate with producers 102 and/or other consumers 104; and the like. In an aspect, consumer 104 accesses infrastructure 101 in order to receive an augmented reality experience comprising content shared by producer 102 and a physical asset 304 including an marker portion 306 (as shown in FIG. 3). Computing device 106 may be a mobile device or it may be a kiosk comprising computing functionality.

In an aspect, an individual may be both producer 102 for other consumers 104 and consumer 104 of content produced by other producers 102.

In various aspects, computing device 106 may be configured as: a tablet computing device or mobile computer 106a or 106f; a mobile device 106b or 106g; a laptop computer 106c or 106h; a mobile telephone 106d or 106i; a Personal Digital Assistant (PDA) 106e or 106j; a desktop computer; any commercially-available intelligent communications device; or the like. Such computing devices may comprise one or more sensors such as a camera, a CCD, near-field communications transceiver, Bluetooth® chip (a wireless technology standard standardized as IEEE 802.15.1), a GPS sensor, and the like. Such sensors may be configured to detect the environmental elements, physical assets, and the like.

As shown in FIG. 1, in an aspect of the present disclosure, an application service provider's cloud-based, communications infrastructure 101 may include one or more web servers 110, an email gateway 112, an SMS gateway 114, an Instant Message (IM) gateway 116, a paging gateway 118, a voice gateway 120, an MMS gateway 128, content database 122, a catalog database 124, and a user database 126. As will be apparent to those skilled in the relevant art(s) after reading the description herein, communications infrastructure 101 may include one or more additional storage, communications and/or processing components to facilitate communication within system 100, processing data, storing content, and the like.

Content database 122 is configured to store content provided by producer 102.

Catalog database 124 is configured to store data, records, and other information related to asset records, partners, partner catalogs, consumer keys, producer keys, catalog generation, asset encoding, catalog utilities, and the like.

User database 126 may be configured to store information about producers 102 and consumers 104 including, but not limited to: account information, producer keys utilized or otherwise associated, consumer keys utilized or otherwise associated, content uploaded, content accessed, infrastructure 101 usage, physical assets utilized, physical assets purchased, and the like. In alternate aspects, user database 126, catalog database 124, or content database 122 may comprise one or more data stores within (or remotely located from) infrastructure 101 or be a memory included in (or coupled to) web server 110.

Content database 122, catalog database 124, and user database 126 may each be physically separate from one another, logically separate, or physically or logically indistinguishable from some or all other databases.

As will be appreciated by those skilled in the relevant art(s) after reading the description herein, in such an aspect, an application service provider—an individual person, business, or other entity—may allow access, on a free registration, paid subscriber and/or pay-per-use basis, to infrastructure 101 via one or more World-Wide Web (WWW) sites on the Internet 108. Thus, system 100 is scalable.

As will also be appreciated by those skilled in the relevant art(s), in an aspect, various screens would be generated by server 110 in response to input from users 102 over Internet 108. That is, in such an aspect, server 110 is a typical web server running a server application at a website which sends out webpages in response to Hypertext Transfer Protocol (HTTP) or Hypertext Transfer Protocol Secured (HTTPS) requests from remote browsers on various computing devices 106 being used by various users 102. Thus, server 110 is able to provide a graphical user interface (GUI) to users 102 of system 100 in the form of webpages. These webpages are sent to the user's PC, laptop, mobile device, PDA or like device 106, and would result in the GUI being displayed.

As will be appreciated by those skilled in the relevant art(s) after reading the description herein, alternate aspects of the present disclosure may include providing a tool for facilitating content sharing coupled with a producer-designated physical asset to devices 106 as a stand-alone system (e.g., installed on one server PC) or as an enterprise system wherein all the components of infrastructure 100 are connected and communicate via an inter-corporate Wide Area Network (WAN) or Local Area Network (LAN). For example, in an aspect where users 102 are all personnel/employees of the same company, the present disclosure may be implemented as a stand-alone system, rather than as a web service (i.e., Application Service Provider (ASP) model utilized by various unassociated/unaffiliated users) as shown in FIG. 1.

As will also be appreciated by those skilled in the relevant art(s) after reading the description herein, alternate aspects of the present disclosure may include providing the tools for facilitating content sharing coupled with a producer-designated physical asset via infrastructure 101 and devices 106 via a browser or operating system pre-installed with an application or a browser or operating system with a separately downloaded application on such devices 106. That is, as will also be apparent to one skilled in the relevant art(s) after reading the description herein, the application that facilitates the content sharing platform herein, may be part of the “standard” browser or operating system that ships with computing device 106 or may be later added to an existing browser or operating system as part of an “add-on,” “plug-in,” or “app store download.”

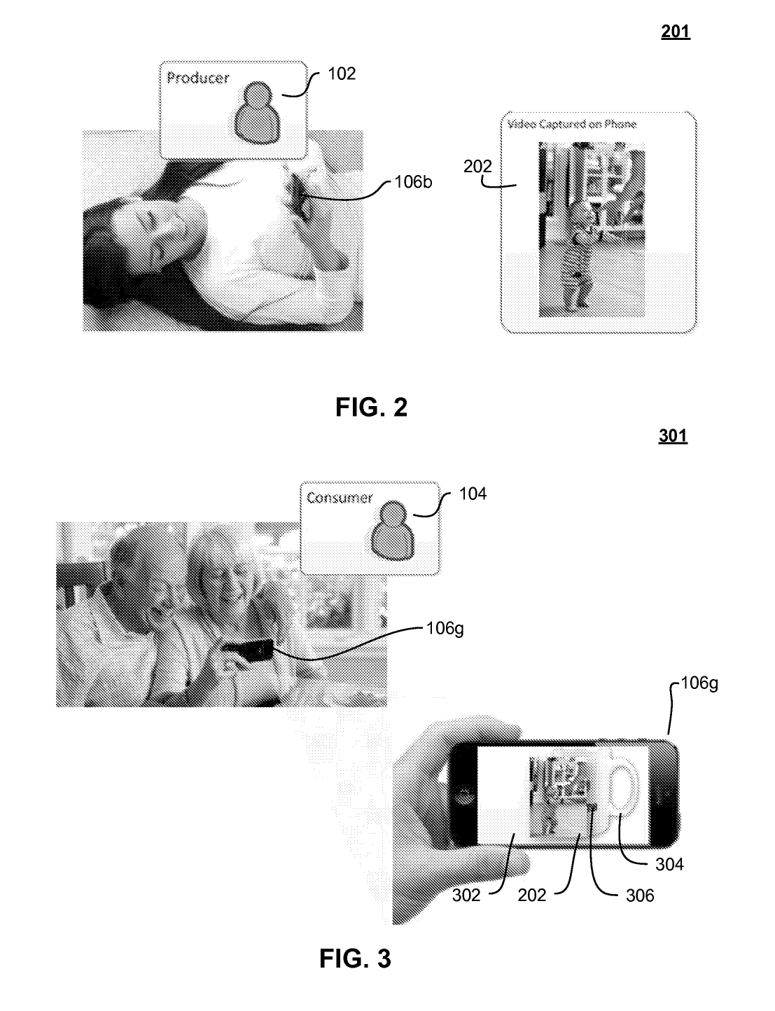

Referring now to FIGS. 2 & 3, image 201 and image 301 illustrating individuals and elements associated with producing and retrieving content coupled with a producer-designated physical asset, according to various aspects of the present disclosure, are shown.

Producer 102 may be an individual wishing to share a video clip 202 created by producer 102 or another with a specific consumer 104 or group of consumers 104. Video clip 202 may be recorded utilizing computing device 106b and uploaded to infrastructure 101 via an application or GUI on computing device 106b. For example, video clip 202 may be a video of a child's first steps. Producer 102 may be the parent of the child in video clip 202. Parent/producer 102 may desire to share the content (i.e., video clip 202) with the child's grandparents. The child's grandparents may be consumers 104 depicted in FIG. 3. Grandparents/consumers 104 may access video clip 202 utilizing systems, methods, and computer program products in accordance with the present disclosure via computing device 106g. Content such as video clip 202 may be presented to consumer 104, such as grandparent, via display 302 of computing device 106g.

Consumer 104 may view video clip 202 using computing device 106g via detecting physical asset 304 with computing device 106g. As shown in FIG. 3, detection may occur by placing physical asset 304 within range of an onboard camera of computing device 106g.

In another aspect, producer 102 may be a company hosting a motocross event at a stadium or other sports event facility. Such producer 102 may wish to share content related to a motocross event with spectators present at the event. Content sharing may occur during the event in real-time, on a predetermined schedule, sporadically, or after the fact. Where consumers 104 (i.e., the spectators) take the linked physical asset with them after the conclusion of the event, producer 102 may continue to share content with consumers 104. Such content may include a highlight reel, interviews, advertisements for upcoming events, and the like.

In another aspect, producer 102 may be a retail venue or associated with a mall. Such producer 102 may wish to share content related to retail venue(s), products, and services with potential customers utilizing systems, methods and computer program products in accordance with the present disclosure. The customers are consumers 104 in this aspect. Physical assets may be all or a portion of: a retail storefront; signage; advertisements; directories; map handouts; and the like.

As will be appreciated by those having skill in the relevant art(s) after reading the description herein, producer 102 may limit how consumer 104 may receive content via several factors including, but not limited to: placement of physical asset 304 within the retail venue or mall; limiting the mobility or portability of physical asset 304; requiring consumer 104 to be within a designated geographic area in order to utilize systems, methods, or computer program products in accordance with the present disclosure; and requiring consumer 104 to access systems, methods, or computer program products in accordance with the present disclosure during limited time periods (e.g., during a sports event, during business hours).

Consumer 104 accesses content via detecting physical asset 304 with one or more sensors associated with computing device 106. Physical asset 304 may be an object such as a cup, t-shirt, bag, promotional item, sign, or the like. Physical asset 304 may be all or a portion of: a retail storefront; signage; advertisements; directories; map handouts; and the like. Physical asset 304 may be a portion of a sports field, arena, obstacle course, motocross course, race course, and the like.

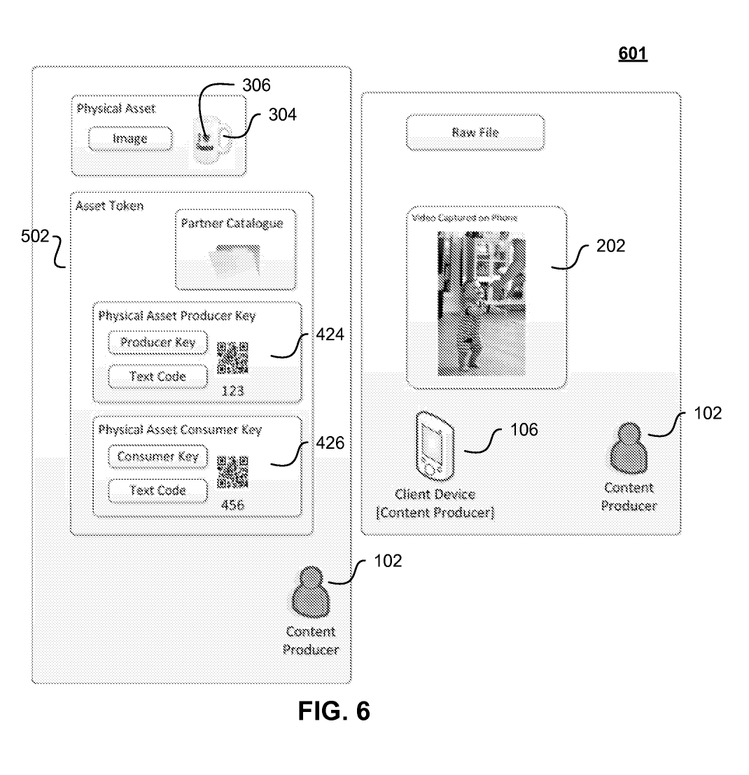

As shown in FIG. 3 and in FIG. 6 in greater detail, physical asset 304 comprises a marker portion 306. Marker portion 306 is all or a portion of physical asset 304 detectable by computing device 106 sensors, thereby facilitating detection of physical asset 304. In an aspect, marker portion 306 does not comprise machine readable areas, such as a QR code, UPC code, or similar. Marker portion 306 may be an aesthetically pleasing image, such as a two-dimensional image comprising the phrase “I Love Grandma,” as shown in FIGS. 3 & 6. Marker portion 306 may comprise aesthetically pleasing markings, symbols, phrases, icons, or the like which may be detected by computing device 106. In another aspect, marker portion is a three-dimensional portion of physical asset 304, such as the arm of a chair, a portion of a sign, and the like. Marker portion 304 may be some or entire exterior surface of physical asset 304, some or the entire interior of physical asset, or some combination thereof. In an aspect, only a part of marker portion 304 need be detected by computing device 106 in order to facilitate detection of physical asset 306. In another aspect, marker portion 306 may be configured to be detectable via near-field communications, radio transmissions, Bluetooth® communications, RFID protocols, and the like. In another aspect, marker portion 306 may be configured to be detectable via emissions generated by marker portion 306, such as electromagnetic radiation, acoustic waves, and the like. Marker portion 306 may be detectable via systems such as LIDAR, SONAR, RADAR, thermal detection, and the like.

In some aspects, marker portion 306 must be oriented in a specific manner (e.g., sideways, vertically) in order to access content such as video clip 202.

Physical asset 304 is selected by producer 102 for linking with content such as video clip 202. Physical asset 304 may be chosen by producer 102 and gifted to consumer 104. Producer 102, a new parent for example, may inform consumer 104 of the content sharing properties of the physical asset 304. In another aspect, physical asset 304 is purchased by consumer 104. The purchase includes access to content shared via systems, methods, and computer program products disclosed herein.

In an aspect, producer 102 is a business, such as a sports event facility management company. Physical asset 304 may be a t-shirt wherein the marker portion 306 is an image of motocross bikes. Consumer 104 may access content related to t-shirt physical asset 304 via scanning the t-shirt with an on-board camera associated with a consumer computing device 106. The on-board camera may detect the marker portion 306 and, in some aspects, physical asset 304 the orientation of one or both and/or movement of one or both, thereby enabling systems, methods, and computer program products for sharing content disclosed herein. Such content may be viewed via, for example computing device 106.

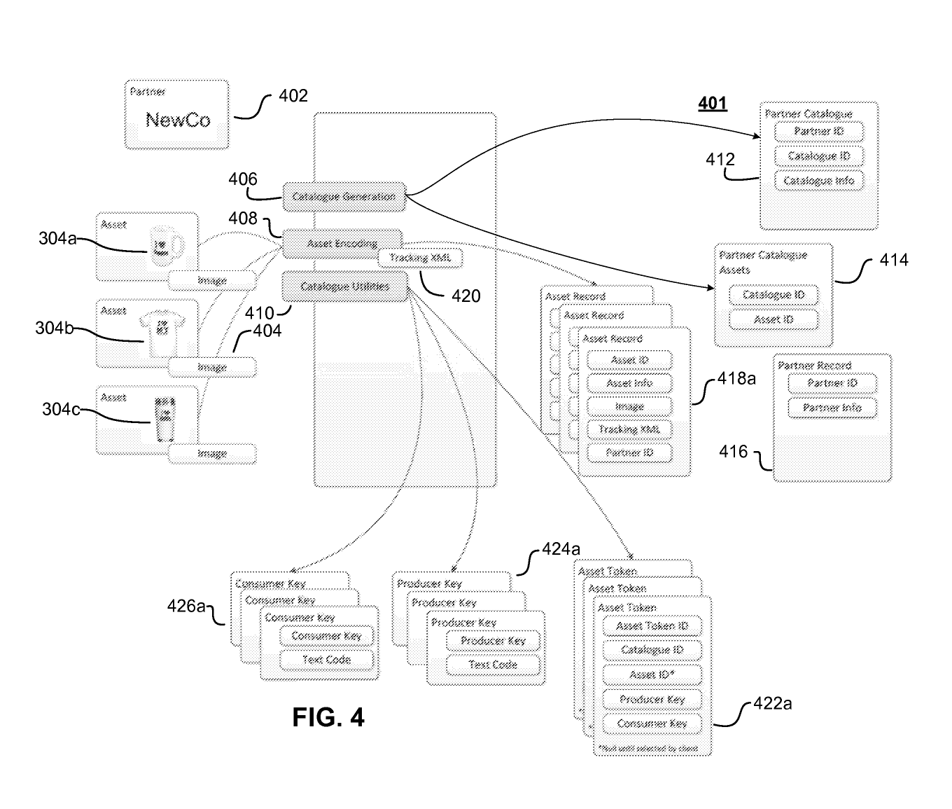

Referring now to FIG. 4, a dataflow diagram 401 of a catalog creation and asset organization process for an exemplary system for facilitating content sharing coupled with a producer-designated physical asset 304, according to an aspect of the present disclosure.

Partner 402 may create and offer for sale or other distribution many different physical assets 304 (shown as physical assets 304a-c in FIG. 4). For example, partner 402 may offer cups 304a, t-shirts 304b, mugs 304c, and the like for sale with a similar “I Love Grandma” logo. In order to enable a physical asset to be utilized herein, image parameters 404 must be created. Image parameters 404 comprise information which enables computing device 106 to detect marker portion 306. In an aspect, image parameters 404 comprise a two-dimensional image of marker portion 306 and tracking XML 420. In another aspect, image parameters 404 comprise a three-dimensional set of coordinates corresponding with the topography of a three-dimensional marker portion 306. Image parameters 404 may be a point cloud, wire frame, or other three-dimensional representation of some or the entirety of physical asset 304. For example, where physical asset 304 is a portion of a retail store, image parameters 404 may be a point cloud of the topographical layout of the retail store. Where physical asset 304 is a toy car, image parameters 404 may be a point cloud of the exterior surface of the toy car.

In another aspect, image parameters comprise data which enables detection of marker portion 306 only when marker portion 306 is in a specified orientation relative to computing device 106. For example, image parameters 404 may require marker portion 306 to be positioned vertically (i.e., “right side up”) relative to computing device 106. Image parameters 306 may require marker portion to be positioned at an angle relative to computing device 106. In another aspect, image parameters 404 may be a marker signal generated by marker portion 306, a three-dimensional representation of all of or a portion of physical asset 304, and the like. In yet other aspects, image parameters 404 include topographical data about physical asset 304, marker portion 306 and the location of marker portion 306 on physical asset 304. In this manner, both the physical asset 304 and the marker portion 306 must be detected in order to facilitate accessing content.

Image parameters 404 and, if applicable, tracking XML, are stored within asset records 418 (shown, for clarity, only as asset record 418a in FIG. 4) on catalog database 124. Asset record 418 may be generated by asset encoding module 408. Asset record 418 may comprise an asset ID, information regarding physical asset 304 (e.g., a description, images), image parameters 404, tracking XML, and a partner ID number.

Catalog generation module 406 may be utilized by partner 402 to create new asset records 418 and store information relevant to physical assets 304 in infrastructure 101. A partner record 416 may be associated with each partner 402, assigning a partner ID to partner 402. Partner record 416 may additionally comprise partner information. Catalog generation module 406 may generate partner catalogs 412 and partner catalog assets 414.

Partner catalog 412 is a record comprising at least one pointer to associated partner record 416. For example, the pointer may be the partner ID. Partner catalog 412 may further comprise catalog information and a unique catalog ID. Partner catalog 412 may be stored in catalog database 124.

Partner catalog assets 414 is a record configured to associate asset records 418 with catalog partner catalog 412. Partner catalog assets 414 may comprise one or more asset IDs and one or more catalog IDs, thereby associating physical assets 304 with partner catalog 412 and partner 402, such as NewCo corporation. Partner catalog asset 414 and asset record 418 may be associated with one or more partner catalogs 412.

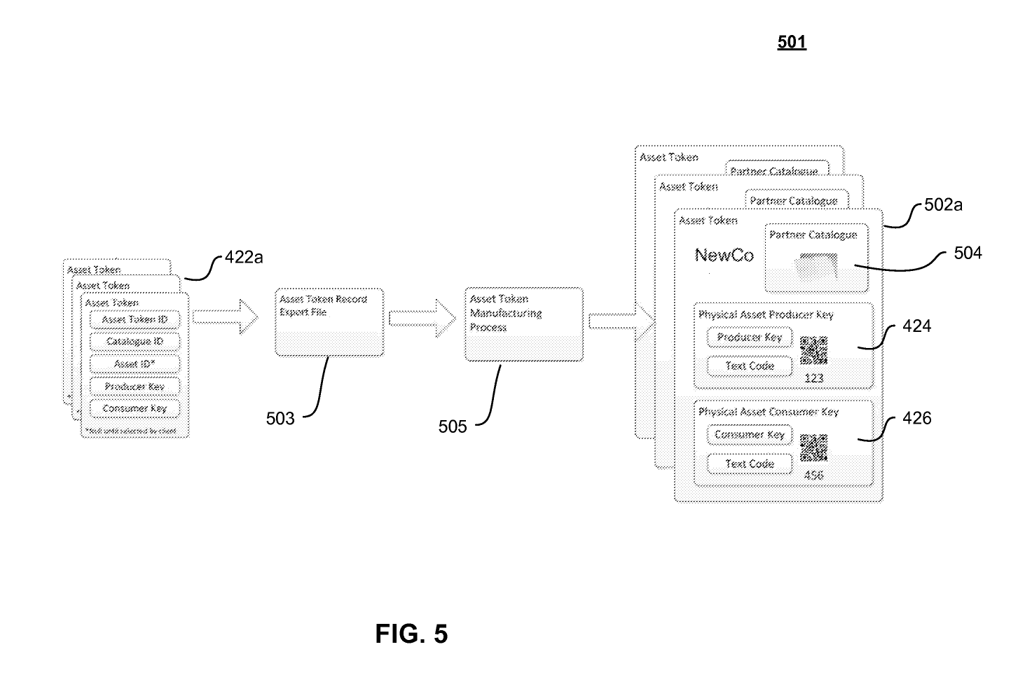

Asset token records 422 (shown, for clarity, only as asset token record 422a in FIG. 4) may be used to generate asset tokens (described with reference to FIG. 5, below). Asset token record 422 comprises catalog ID pointers, producer keys 424 (shown, for clarity, only as producer key 424a in FIG. 4), and consumer keys (shown, for clarity, only as consumer key 426a in FIG. 4). Asset token record 422 may be stored on catalog database 124, or elsewhere within infrastructure 101.

Producer key 424 is a code, image, password, or other data set which enables producer 102 to associate content with physical asset 304. In an aspect, producer 102 provides producer key 424 to infrastructure 101 in order to associate video clip 202 with physical asset 304. Producer key 424 may be provided to producer 102 when producer 102 initially purchases physical asset 304 (e.g., on a flyer or tag included with the purchase). In another aspect, producer key 424 may be provided to producer 102 via electronic delivery (e.g., an email, an in-application message, MMS, SMS, and the like). Producer 102 may provide producer key 424 by inputting a specified text code into computing device 106, scanning a QR code, and the like.

Consumer key 426 is a code, image, password, or other data set which consumer 104 must provide in order to access content associated with physical asset 304 detected by computing device 106. In an aspect, consumer key 426 secures the ability of consumer 104 to access an augmented reality experience linked with physical asset 304. Consumer 104 may receive consumer key 426 from producer 102 via electronic delivery (e.g., an email, an in-application message, MMS, SMS, link within a social media environment, and the like) or physical delivery (directly or via a third party). Consumer key 426 may be associated with a consumer account within system 100, thereby enabling consumer 104 to access content via logging in. Consumer 104 may provide consumer key 426 by inputting a specified text code into computing device 106, scanning a QR code, and the like.

In an aspect, consumer 104 must provide additional information or satisfy one or more additional criteria in order to access content associated with physical asset 304. For example, consumer 104 may be required to detect physical asset 304 with computing device 106 when computing device 106 is located within a specified area, as defined by GPS coordinates (i.e., geographic fencing). In another aspect, content associated with physical asset 304 is only available at a specific time (e.g., bed time, 3-6 p.m. ET, every Monday, a single day, and the like. In yet another aspect, consumer 104 may be required to supply an additional password or other credential. In yet another aspect, consumer 104 must image physical asset 304 and/or marker portion 306 at a specific orientation or series of orientations (i.e., move and/or rotate physical asset) in order to access content.

In an aspect, consumer key 426 need not be provided each to consumer 104 who wishes to access content associated with physical asset 304. Rather, consumer key 426 may be initially provided (by consumer 104, via infrastructure 101, or some other means) and stored in infrastructure 101 (e.g., in user database 126), linked to consumer's social networking account, or otherwise associated with consumer 104 and made available for utilization. As will be apparent to those skilled in the relevant art(s) after reading the description herein, producer key 424 may be stored in a similar fashion, thereby enabling producer 102 to edit or otherwise alter content associated with physical asset without providing producer key each time the content is edited or otherwise altered.

Referring now to FIG. 5, a dataflow diagram 501 of an asset token creation process for an exemplary system for facilitating content sharing coupled with a producer-designated physical asset 304, according to an aspect of the present disclosure, is shown.

Asset token 502 (shown, for clarity, only as asset token 502a in FIG. 5) may be generated via the process detailed in dataflow diagram 501. Asset token 502 is a physical or digital object comprising producer key 424, consumer key 426, and catalog pointer 504. Asset tokens 502 may be generated from asset token records 422 via first collecting a plurality of asset token records in an asset token record export file 503. Export file 503 may be a comma separated variable (CSV) file. Export file 503 is utilized by an asset token manufacturing process 505 to generate physical and/or digital asset tokens 502 which may be utilized by producers 102 and consumers 104 to facilitate sharing content in accordance with the present disclosure.

Asset token manufacturing process 505 may be configured to produce physical asset tokens 502 which are associated with physical assets 304 before distribution to or purchase by producer 102. In an aspect, asset token 502 is a physical object sold with physical asset 304 and comprises partner 402 branding and a graphic identifying the corresponding physical asset 304. Asset token 502 may additionally comprise visual instructions showing wear marker portion 306 is located on physical asset 304.

Referring now to FIG. 6, an image 601 illustrating individuals and elements associated with producing content which may be shared via an exemplary system for facilitating content sharing coupled with a producer-designated physical asset 304, according to an aspect of the present disclosure, is shown.

In order to facilitate content sharing, producer may initially purchase or otherwise select or acquire physical asset 304. Producer 102 may receive an associated asset token 502. Producer 102 creates video clip 202 via computing device 106. Video clip 202 may be a raw file in the native format created by computing device 106. In another aspect, producer provides content, such as an audio file or image for sharing with consumer 104.

In an aspect, producer 102 acquires physical asset 304 and asset token 502 simultaneously (e.g., via a purchase transaction at a retailer). In another aspect, physical asset 304 may acquired separately from asset token 502. Producer 102 may purchase physical asset 304 not initially associated with producer key 424 and consumer key 426. Partner 402, such as a holiday shop, may provide image parameters 404 for some or all products sold by the retailer to service provider, such as an ASP. Producer 102, or another party, may first purchase or select physical asset 304, such as a holiday ornament, within the holiday shop. Producer 102 may take the holiday ornament to a kiosk located inside the holiday shop where producer 102 purchases an access pass to an augmented reality experience as disclosed herein. Producer 102 provides identifying information about physical asset 304 purchased (i.e., the holiday ornament). The access pass comprises producer key 424 and consumer key 426 associated with image parameters 404 of physical asset 304 purchased by producer 102, thereby enabling producer 102 to create and link content, such as video clip 202 with the purchased physical asset 304, give the physical asset 304 and consumer key 426 to consumer 104, and share the content with consumer 104.

Where physical asset 304 is associated with producer key 424 and consumer key 426 at a kiosk, token manufacturing process 505 may occur within the kiosk. The access pass may comprise asset token 502.

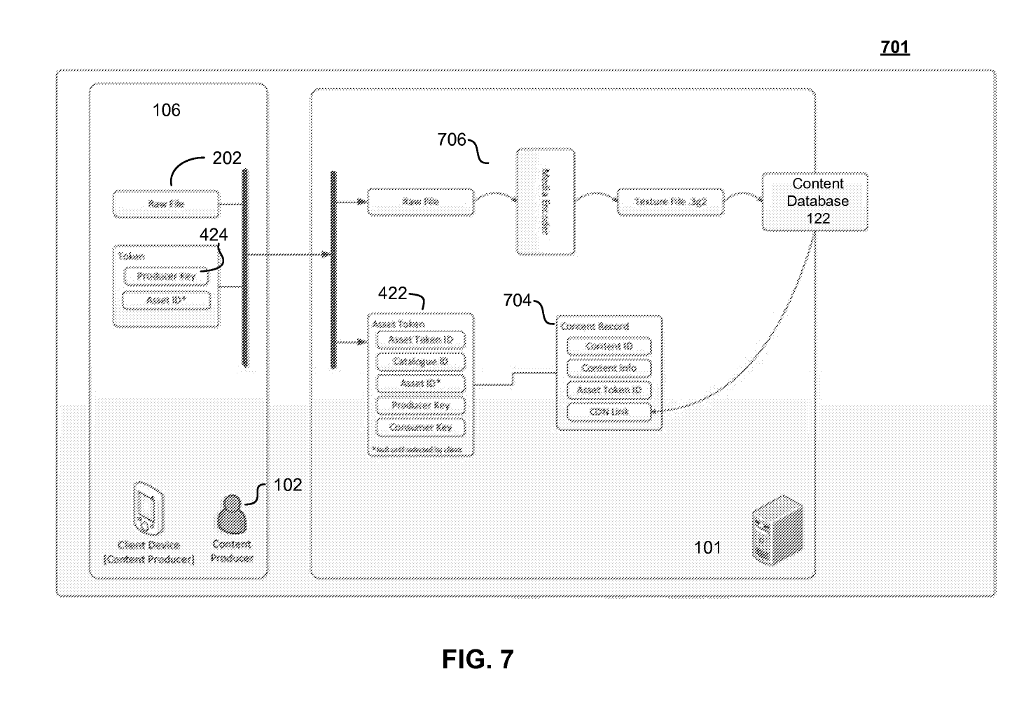

Referring now to FIG. 7, a dataflow diagram 701 of a content sharing process for an exemplary system for facilitating content sharing coupled with a producer-designated physical asset 304, according to an aspect of the present disclosure, is shown.

Producer 102 may provide infrastructure 101 with video clip 202 and producer key 424, thereby linking video clip 202 with asset token record 422 and the corresponding consumer key 426. Infrastructure 101 may process video clip 202, or other content received from producer 102, via encoding process 706. Encoding process 706 is configured to convert content into a format which may be stored on content database 122 and shared with consumer 104 via computing device 106.

A content record 704 associated with video clip 202 or other content provided by producer 102 is generated and stored with in infrastructure 101. Content record 704 provides a content ID, content information, a pointer to asset token record 422, and a pointer to content location within content database 122, thereby enabling infrastructure 101 to access content and present such content to consumer 104 when provided with consumer key 426 and image parameters 404 associated with asset token record 422.

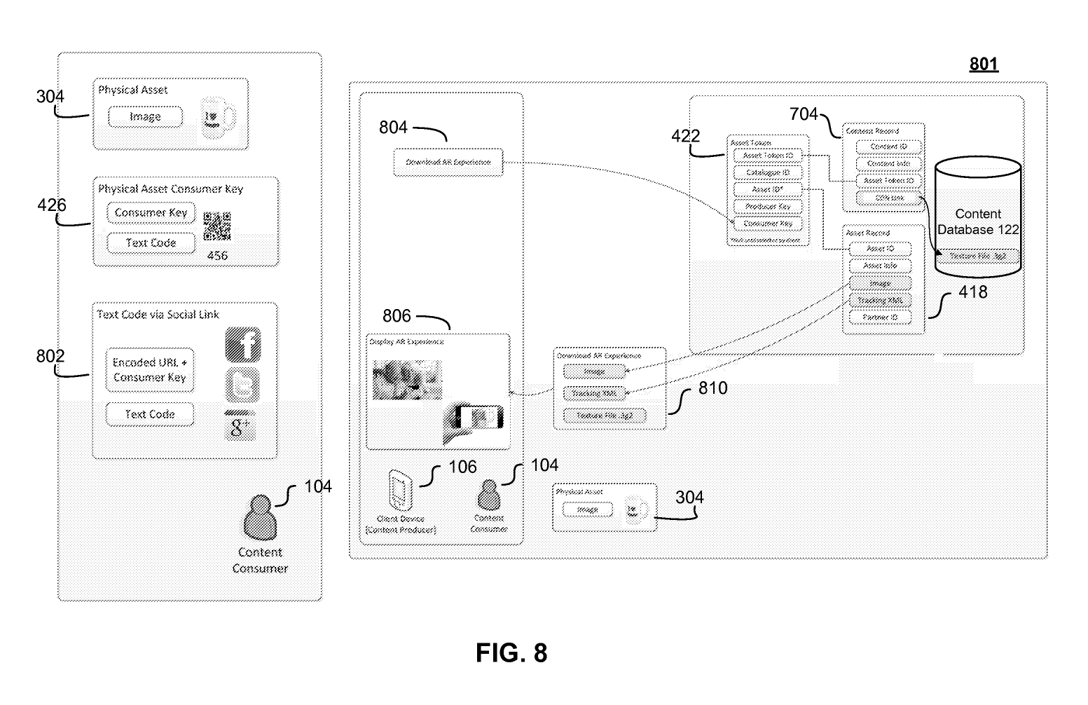

Referring now to FIG. 8, a dataflow diagram 801 of a content consuming process for an exemplary system for facilitating content sharing coupled with a producer-designated physical asset 304, according to an aspect of the present disclosure, is shown.

In order to access content provided by producer 102, consumer must detect physical asset 304 with computing device 106 and provide consumer key 426 associated with physical asset 304 via asset token record 422.

In an aspect, consumer 104 may receive a text code 802 indicating producer 102 would like to share content with consumer 104 and prompting consumer to download an application enabling the augmented reality experience disclosed herein. Consumer may download the augmented reality experience application 804 onto mobile device 106 and provide consumer key 426. In an aspect, consumer key 426 need not be provided each time consumer 104 seeks to access content. Rather, consumer 104 may provide consumer key 426 once and consumer key 426 may thereafter be associated with consumer 104, consumer's computing device 106, consumer account, or the like. Data related 810 to accessing content may be downloaded or otherwise accessed by computing device 106. In an aspect, when an on board camera of computing device 106 scans marker portion 306 of physical asset 304, content is presented via a display on computing device, provided that the associated consumer key 426 has also been provided. If computing device 106 is moved away from physical asset 304, content may cease being displayed.

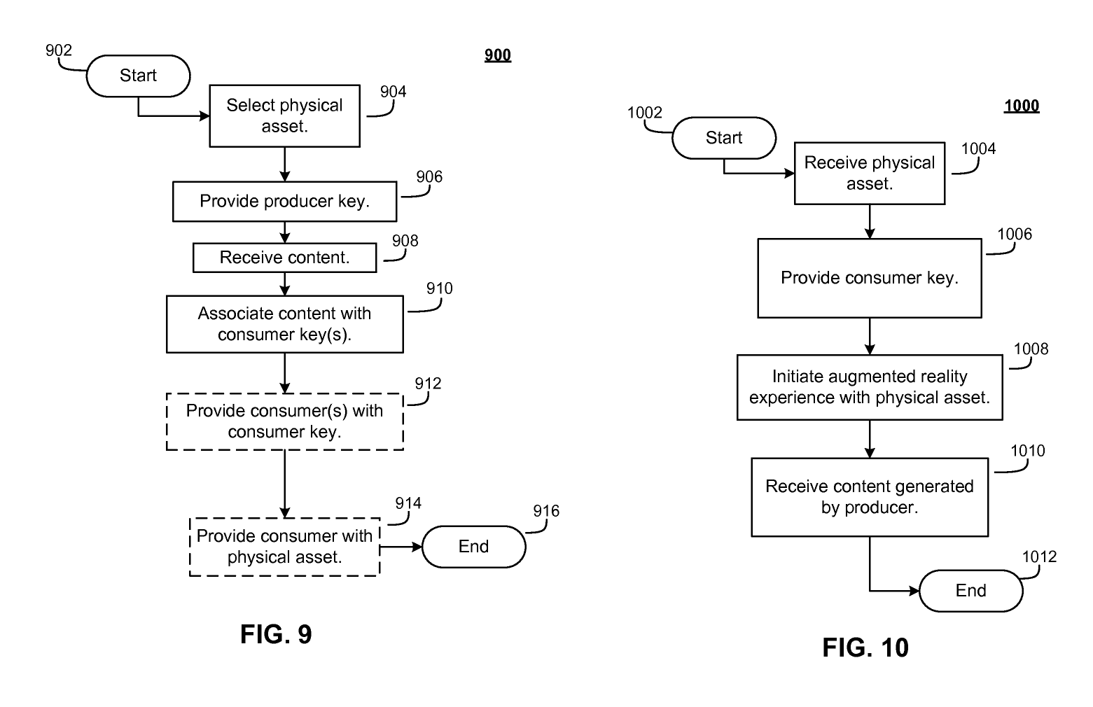

Referring now to FIG. 9, a flowchart illustrating an exemplary process 900 for creating content and an associated augmented reality experience, according to an aspect of the present disclosure, is shown.

Process 900, which may execute within system 100 and facilitate content sharing linked to physical asset 304, begins at step 902 with control passing immediately to step 904.

At step 904, producer 102 selects of physical asset 904. Selection indicates physical asset 304 producer 102 desires to associate content with.

At step 906, infrastructure 101 receives producer key 424 from producer 102.

At step 908, upon receipt of producer key 424, producer 102 may provide content to be associated with physical asset 304. Such association may be an initial association, or producer 102 may be updating content associated with physical asset 304.

At step 910, content received at step 908 is associated with one or more consumer keys 426. In an aspect, this association is accomplished via the association present in asset token record 422. In another aspect, one or more consumer keys 426 and physical assets 304 may be selected for association with content, thereby enabling sharing of content with multiple consumers 104 who possess different consumer keys 426 and/or different physical assets 304.

At optional step 912, consumer 104 is provided with consumer key 426. In an aspect, producer 102 may provider consumer 104 with consumer key 426 via physically giving consumer an object containing information about consumer key 426. For example, where consumer key 426 is an alphanumeric code, producer 102 may give consumer 104 a document with the alphanumeric code consumer key 426 printed on it. In another aspect, producer 102 or a third party, or infrastructure 101 may electronically send consumer key 426 to consumer.

At optional step 914, consumer 104 is provided with physical asset 304 which, when detected by computing device 106, may facilitate accessing content. In an aspect, producer 102 may give physical asset 304 to consumer 104. In another aspect, a third party may provide consumer 104 with physical asset 304. In an alternative aspect, consumer 104 may be directed to purchase a specified physical asset 304 or otherwise acquire, locate, or encounter physical asset 304.

Process 900 then terminates at step 916.

Referring now to FIG. 10, a flowchart illustrating an exemplary process 1000 for consuming content associated with a physical asset 304, according to an aspect of the present disclosure, is shown.

Process 1000, which may be carried out on portions of infrastructure 101, begins at step 1002 with control immediately passing to step 1004.

At step 1004, consumer 104 encounters physical asset 304. In an aspect, physical asset 304 is a coffee mug comprising an “I love Grandma” image, the marker portion 306. Consumer 104 may receive the coffee mug physical asset 304 as a gift.

In another aspect, physical asset 304 is a store front in a mall. In such an aspect, consumer 104 encounters physical asset 304 while walking in the mall.

At step 1006, infrastructure is provided with consumer key 426 associated with physical asset 304. Step 1006 may occur before, concurrently with, or after step 1004. As will be appreciated by those skilled in the relevant art(s) after reading the description herein, consumer key 426 may be provided by consumer 104, a third party, a portion of infrastructure 101, or another means.

At step 1008 an augmented reality experience with physical asset 304 is initiated by consumer 104. Consumer 104 may cause computing device 106 to detect physical asset. In an aspect, consumer computing device 106 is configured to compare information collected about the consumer's surroundings via computing device sensors with image parameters 404. Computing device 106 may detect marker portion 306 and compare such information with image parameters 404. Such a comparison may yield a match, indicating the presence of physical asset 304.

In an aspect, physical asset 304 is a coffee mug comprising a matching “I love Grandma” image, the marker portion 306. A camera module on computing device 106 may scan the coffee mug and capture a photograph of the “I Love Grandma” image on the coffee mug. The captured photograph may then be compared to the image parameters 404, facilitating detection of physical asset 304 associated with the “I Love Grandma” image parameters 404.

At step 1010, after receiving consumer key 426 and detecting physical asset 304, the associated content may be displayed by computing device 106, thereby enabling the content to be shared with consumer 104.

Process 1000 then terminates at step 1012.

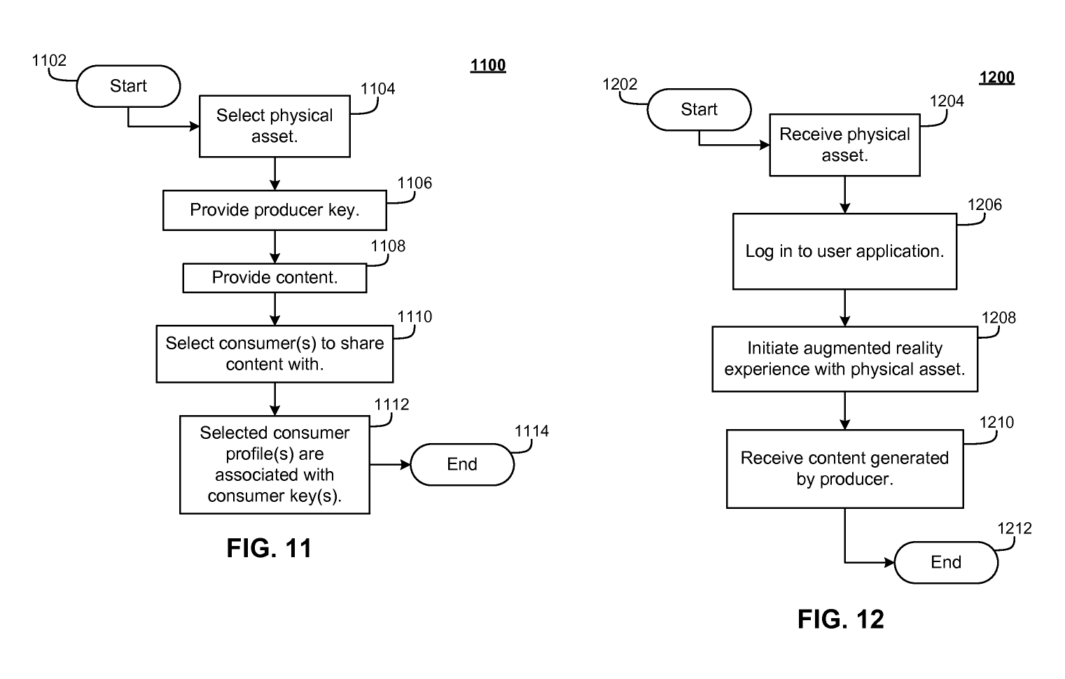

Referring now to FIG. 11, a flowchart illustrating an exemplary process 1100 for creating content and assigning access to consumer 104, according to aspects of the present disclosure, is shown.

Process 1100, which may execute within system 100 and facilitate content sharing linked to physical asset 304 via assigning the augmented reality experience to a consumer user profile, begins at step 1102 with control passing immediately to step 1104.

At step 1104, producer 102 selects of physical asset 904.

At step 1106, infrastructure 101 receives producer key 424 from producer 102. Producer 102 may provider producer key 424 via computing device 106.

At step 1108, producer 102 provides the content to be shared with consumer 104. The content may be provided to infrastructure 101 via computing device 106.

At step 1110, infrastructure 101 presents producer 102 with a list of users. In some aspects, the user list is generated via integration with third-party software, such as a social network application programming interface which exposes a list of producer's contacts (e.g., a friend list) within the third-party software. Producer 102 then selects one or more users from the list of users to share the provided content with. The selected users are consumers 104.

At step 1112, infrastructure 101 associates consumer(s) 104 selected in step 1110 with consumer key 426 associated with producer key 424 provided in step 1106. In some aspects, consumer key is associate with the user profile of consumer 104.

Process 1100 then terminates at step 1114.

Referring now to FIG. 12, a flowchart illustrating an exemplary process 1200 for consuming content, consumer keys 426 for consuming the content being associated with a consumer profile accessible by logging in, according to aspects of the present disclosure, is shown.

Process 1200 which may execute within system 100 and facilitate accessing an augmented reality experience by consumer 104 wherein consumer 104 has a user profile within infrastructure 101 and one or more consumer keys 426 are associated with that user profile, begins at step 1202 with control passing immediately to step 1204.

At step 1204, consumer 104 encounters or otherwise receives physical asset 304.

At step 1206, consumer 104 logs into a user application associated with infrastructure 101 via computing device 106. Consumer 104, or computing device 106, may provide log in credentials, accessing a user profile for consumer 104. One or more consumer keys 426 may be associated with the user profile, as described in reference to process 1100. One or more of consumer keys 426 may be associated with physical asset 304 received at step 1204. In some aspects, consumer may log in using a login service such as a social media login service, an identity/credential provider service, a single sign on service, and the like. In various aspects, producers 102 and/or consumers 104 may create user profiles via such login services.

At step 1208, an augmented reality experience with physical asset 304 is initiated by consumer 104. Consumer 104 may cause computing device 106 to detect physical asset.

At step 1210, after detecting physical asset 304, the associated content may be displayed by consumer computing device 106, thereby enabling the content to be shared with consumer 104.

Process 1200 then terminates at step 1212.

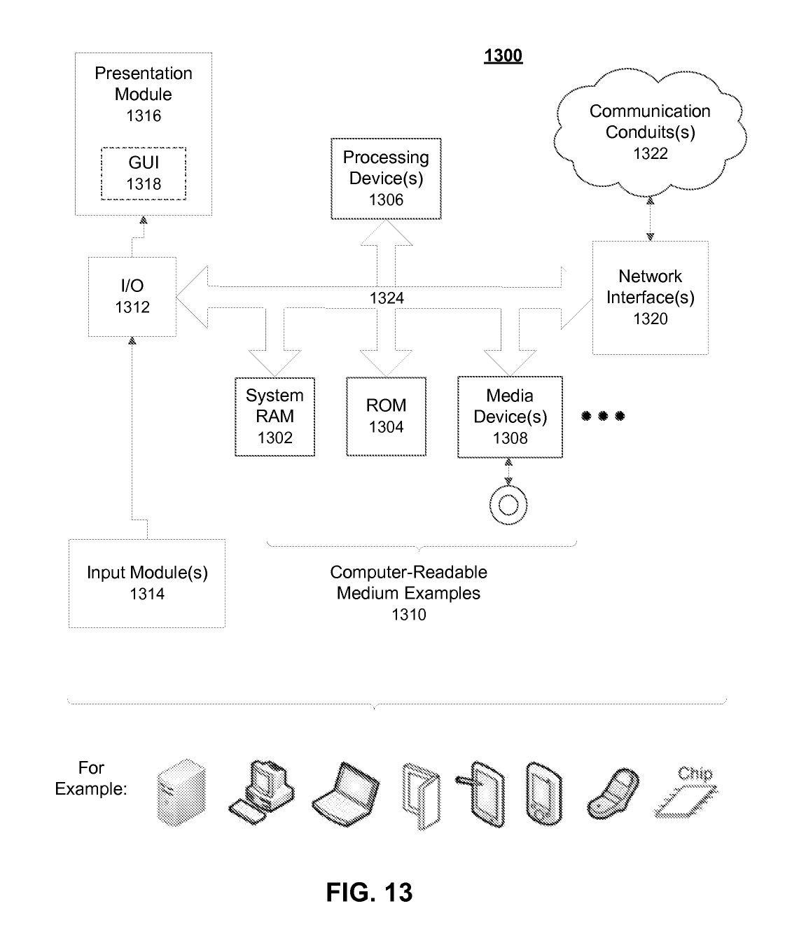

Referring now to FIG. 13, a block diagram of an exemplary computer system useful for implementing various aspects the processes disclosed herein, in accordance with one or more aspects of the present disclosure, is shown

That is, FIG. 13 sets forth illustrative computing functionality 1300 that may be used to implement web server 110, one or more gateways 112-120, content database 122, catalog database 124, user database 126, computing devices 106 utilized by producer 102 or consumer 104 to access Internet 108, or any other component of system 100. In all cases, computing functionality 1300 represents one or more physical and tangible processing mechanisms.

Computing functionality 1300 may comprise volatile and non-volatile memory, such as RAM 1302 and ROM 1304, as well as one or more processing devices 1306 (e.g., one or more central processing units (CPUs), one or more graphical processing units (GPUs), and the like). Computing functionality 1300 also optionally comprises various media devices 1308, such as a hard disk module, an optical disk module, and so forth. Computing functionality 1300 may perform various operations identified above when the processing device(s) 1306 execute(s) instructions that are maintained by memory (e.g., RAM 1302, ROM 1304, and the like).

More generally, instructions and other information may be stored on any computer readable medium 1310, including, but not limited to, static memory storage devices, magnetic storage devices, and optical storage devices. The term “computer readable medium” also encompasses plural storage devices. In all cases, computer readable medium 1310 represents some form of physical and tangible entity. By way of example, and not limitation, computer readable medium 1310 may comprise “computer storage media” and “communications media.”

“Computer storage media” comprises volatile and non-volatile, removable and non-removable media implemented in any method or technology for storage of information, such as computer readable instructions, data structures, program modules, or other data. Computer storage media may be, for example, and not limitation, RAM 1302, ROM 1304, EEPROM, Flash memory, or other memory technology, CD-ROM, digital versatile disks (DVD), or other optical storage, magnetic cassettes, magnetic tape, magnetic disk storage, or other magnetic storage devices, or any other medium which can be used to store the desired information and which can be accessed by a computer.

“Communication media” typically comprise computer readable instructions, data structures, program modules, or other data in a modulated data signal, such as carrier wave or other transport mechanism. Communication media may also comprise any information delivery media. The term “modulated data signal” means a signal that has one or more of its characteristics set or changed in such a manner as to encode information in the signal. By way of example, and not limitation, communication media comprises wired media such as a wired network or direct-wired connection, and wireless media such as acoustic, RF, infrared, and other wireless media. Combinations of any of the above are also included within the scope of computer readable medium.

Computing functionality 1300 may also comprise an input/output module 1312 for receiving various inputs (via input modules 1314), and for providing various outputs (via one or more output modules). One particular output module mechanism may be a presentation module 1316 and an associated GUI 1318. Computing functionality 1300 may also include one or more network interfaces 1320 for exchanging data with other devices via one or more communication conduits 1322. In some embodiments, one or more communication buses 1324 communicatively couple the above-described components together.

Communication conduit(s) 1322 may be implemented in any manner (e.g., by a local area network, a wide area network (e.g., the Internet), and the like, or any combination thereof). Communication conduit(s) 1322 may include any combination of hardwired links, wireless links, routers, gateway functionality, name servers, and the like, governed by any protocol or combination of protocols.

Alternatively, or in addition, any of the functions described herein may be performed, at least in part, by one or more hardware logic components. For example, without limitation, illustrative types of hardware logic components that may be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

The terms “module” and “component” as used herein generally represent software, firmware, hardware, or combinations thereof. In the case of a software implementation, the module or component represents program code that performs specified tasks when executed on a processor. The program code may be stored in one or more computer readable memory devices. The features of the present disclosure described herein are platform-independent, meaning that the techniques can be implemented on a variety of commercial computing platforms having a variety of processors (e.g., set-top box, desktop, laptop, notebook, tablet computer, personal digital assistant (PDA), mobile telephone, smart telephone, gaming console, and the like).

While various aspects of the present disclosure have been described above, it should be understood that they have been presented by way of example and not limitation. It will be apparent to persons skilled in the relevant art(s) that various changes in form and detail can be made therein without departing from the spirit and scope of the present disclosure. Thus, the present disclosure should not be limited by any of the above described exemplary aspects, but should be defined only in accordance with the following claims and their equivalents.

In addition, it should be understood that the figures in the attachments, which highlight the structure, methodology, functionality and advantages of the present disclosure, are presented for example purposes only. The present disclosure is sufficiently flexible and configurable, such that it may be implemented in ways other than that shown in the accompanying figures (e.g., implementation within computing devices and environments other than those mentioned herein). As will be appreciated by those skilled in the relevant art(s) after reading the description herein, certain features from different aspects of the systems, methods and computer program products of the present disclosure may be combined to form yet new aspects of the present disclosure.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present disclosure in any way.

What is claimed is:

1. A computer-implemented method for facilitating capturing and associating content for an augmented reality experience for a producer-designated consumer, the method comprising the steps of:
(a) capturing, via a mobile device operated by a producer, content, wherein the content will be shared with a consumer;
(b) providing a producer key, wherein the producer key is associated with, within at least one application service provider (ASP) database:
a physical asset, the physical asset having an aesthetically pleasing marker portion positioned thereon; and
a consumer key;
(c) uploading the captured content to the at least one ASP database;
(d) associating the uploaded content with the provided producer key; and
(e) providing the consumer key to the consumer;
wherein the database provides the consumer access to the captured content via a consumer mobile device when the consumer key is provided and the consumer mobile device detects the marker portion;
wherein the consumer key must be provided in order to access the captured content associated with the producer key and the physical asset; and
wherein the producer may, by providing the producer key and a second content to the at least one ASP database, alter content associated with the physical asset for the consumer.

2. The method of claim 1, wherein the consumer key is provided to the consumer via the step of:
(f) associating, via an ASP GUI, the consumer key with the consumer.

3. The method of claim 2, wherein the at least one ASP database comprises a consumer user profile; and
wherein associating step (f) links the consumer key with the consumer user profile.

4. The method of claim 1, further comprising the step of:
(f) providing, by the producer, the physical asset to the consumer.

5. The method of claim 1, wherein the producer key is associated with image parameters stored on the at least one ASP database, wherein the image parameters comprise detection information which enables the consumer mobile device to detect the marker portion.

6. The method of claim 5, wherein the image parameters are one of: a two-dimensional representation of the marker portion; and a three-dimensional representation of the marker portion.

7. A computer-implemented method for facilitating an augmented reality experience for a producer-designated consumer including content generated by a producer linked to a physical asset by the producer, the method comprising the steps of:
(a) providing at least one application service provider (ASP) database, the at least one ASP database comprising:
a producer key; and
a consumer key;
wherein the producer key and the consumer key are linked and the producer key and the consumer key are associated with a physical asset the physical asset having an aesthetically pleasing marker portion positioned thereon;
(b) receiving, from a producer mobile device, content, wherein the content will be shared with a consumer;
(c) receiving, from the producer, a producer key;
(d) storing the received content in the at least one ASP database;
(e) associating, within the at least one ASP database, the stored content with the consumer key and the physical asset related to the received producer key;
(f) receiving, via the consumer, the consumer key;
(g) receiving, from a consumer mobile device, identification of the physical asset, wherein identification is via detection of the marker portion by a consumer mobile device onboard sensor; and
(h) providing, to the consumer mobile device, the associated content, wherein the provided content is presented to the consumer via the consumer mobile device;
wherein the consumer key is provided to the consumer by the producer; and
wherein, upon receiving the producer key and a second content from the producer mobile device, the second content is associated with the consumer key and the physical asset related to the received producer key.

8. The method of claim 7, the method further comprising the step of:
(i) assigning, within the at least one ASP database, the consumer key to the consumer;
wherein a consumer user account is contained within the at least one ASP database; and
wherein the consumer user account is associated with the consumer and assigning step (i) links the consumer key to the consumer user account.

9. The method of claim 8, wherein, within the at least one ASP database, multiple consumer keys may be associated with the consumer user account.

10. The method of claim 9, wherein, in receiving step (f), the consumer key is received from the consumer user account.

11. The method of claim 8, further comprising the step of:
(j) confirming, via an electronic message to the producer, assigning step (i).

12. The method of claim 8, further comprising the step of:
(j) populating, via a third-party social network login service, the consumer user account with third-party social network information.

13. The method of claim 7, further comprising the step of:
(i) providing, to the consumer mobile device, an available content notification wherein the available content notification comprises content information and physical asset information.

14. The method of claim 13, wherein the available content notification is provided via a social network communication.

15. The method of claim 7, wherein, in receiving step (f), the consumer key is received from the consumer mobile device.

16. The method of claim 7, wherein the producer key is associated with image parameters stored on the at least one ASP database;
wherein the image parameters comprise detection information which enables the consumer mobile device to detect the marker portion.

17. The method of claim 16, wherein the image parameters are one of: a two-dimensional representation of the marker portion; and a three-dimensional representation of the marker portion.

18. The method of claim 17, wherein the image parameters further comprise physical asset parameters, the physical asset parameters being one of: a two-dimensional representation of the physical asset; and a three-dimensional representation of the physical asset;
wherein the consumer accesses the captured content via the consumer mobile device when the consumer key is provided, the consumer mobile device detects the marker portion via utilization of the image parameters, and the physical asset is detected via utilization of the physical asset parameters.

19. The method of claim 18, wherein the image parameters comprise at least one of: a point cloud; and a wire frame.

20. The method of claim 16, wherein the image parameters comprise orientation information;
wherein the orientation information specifies the relative orientation of the consumer mobile device onboard sensor and the marker portion.

21. The method of claim 7, further comprising the step of:
(i) receiving, at the at least one ASP database, additional display criteria;
wherein the captured content is provided to the consumer mobile device when the additional display criteria are satisfied.

22. The method of claim 21, wherein the additional display criteria is at least one of: a proximity to a defined location; a time period; a time; a password; and a series of movements of the consumer mobile device.

23. The method of claim 21, wherein the additional display criteria is received from the producer.

24. The method of claim 21, further comprising the step of:
(j) generating, via an ASP access module, the additional display criteria;
wherein the additional display criteria is received from the ASP access module.

25. The method of claim 7, wherein the marker portion is at least a portion of the physical asset.

26. The method of claim 7, wherein the marker portion is one of: a two-dimensional object; and a three-dimensional object.

27. A computer system for facilitating an augmented reality experience for a producer-designated consumer including content generated by a producer linked to a physical asset by the producer, comprising:
(a) a plurality of mobile devices operated by a plurality of producers and consumers, each of the plurality of mobile devices having a user application stored thereon, configured to communicate via a communications network;
(b) at least one application service provider (ASP) database, the at least one ASP database comprising:
a producer key; and
a consumer key;
wherein the producer key and the consumer key are linked and the producer key and the consumer key are associated with a physical asset the physical asset having an aesthetically pleasing marker portion positioned thereon; and
(c) at least one ASP server configured to communicate, via the communications network, with the plurality of mobile devices and the at least one ASP database, the at least one application service provider comprising:
(i) a content collection service configured to receive, from a producer mobile device, content and store the received content in the at least one ASP database, wherein the content will be shared with a consumer,
(ii) a content association service configured to receive, from the producer mobile device, a producer key and associate the stored content with the consumer key and the physical asset related to the received producer key;
(iii) a content access service configured to receive, via the consumer, the consumer key, receive from a consumer mobile device, identification of the physical asset, wherein identification is via detection of the marker portion by a consumer mobile device onboard sensor, and provide, to the consumer mobile device, the associated content, wherein the provided content is presented to the consumer via the consumer mobile device;
wherein the consumer key is provided to the consumer by the producer; and
wherein, upon receiving the producer key and a second content from the producer mobile device, the second content is associated with the consumer key and the physical asset related to the received producer key

28. One or more computer storage media having stored thereon multiple instructions that facilitate an augmented reality experience for a producer-designated consumer including content generated by a producer linked to a physical asset by the producer by, when executed by one or more processors of a computing device, causing the one or more processors to:
(a) provide at least one application service provider (ASP) database, the at least one ASP database comprising:
a producer key; and
a consumer key;
wherein the producer key and the consumer key are linked and the producer key and the consumer key are associated with a physical asset the physical asset having an aesthetically pleasing marker portion positioned thereon;
(b) receive, from a producer mobile device, content, wherein the content will be shared with a consumer;
(c) receive, from the producer mobile device, a producer key;
(d) store the received content in the at least one ASP database;
(e) associate, within the at least one ASP database, the stored content with the consumer key and the physical asset related to the received producer key;
(f) receive, via the consumer, the consumer key;
(g) receive, from a consumer mobile device, identification of the physical asset, wherein identification is via detection of the marker portion by a consumer mobile device onboard sensor; and
(h) provide, to the consumer mobile device, the associated content, wherein the provided content is presented to the consumer via the consumer mobile device;
wherein the consumer key is provided to the consumer by the producer; and
wherein, upon receiving the producer key and a second content from the producer mobile device, the second content is associated with the consumer key and the physical asset related to the received producer key.
